(19) United States
(12) Patent Application Publication
(10) Pub. No.: US 2015/0242871 A1
(43) Pub. Date: Aug. 27, 2015

(54) METHOD AND DEVICE FOR AWARDING DISCOUNTS, COUPONS AND PROMOTIONS TO CUSTOMERS

(71) Applicants: Evelyn Ortiz, Encinitas, CA (US); Charles Federspiel, San Jose, CA (US)

(72) Inventors: Evelyn Ortiz, Encinitas, CA (US); Charles Federspiel, San Jose, CA (US)

(21) Appl. No.: 14/187,101

(22) Filed: Feb. 21, 2014

(51) Int. Cl. G06Q 30/02; H04W 8/08; H04L 29/08

(52) U.S. Cl. CPC G06Q 30/0209; H04L 67/10; H04W 8/08

(57) ABSTRACT

A system and method for awarding promotions, ads, and coupons to customers. A participating business provides a Wi-Fi Local Area Network that includes a location identifier. One or more hand held programmable wireless communication devices are present on the network. The location identifier and the wireless communication devices are in constant communication with a registry server, which is connected to the Local Area Network via the Internet. The registry server, using data provided by the location identifier, is able to aggregate wireless communication devices into a location-specific social network. The wireless communication devices are programmed to allow users to access and play a mobile game App to earn points. These points are converted into a coupon that can be redeemed at the participating business. Play of the game or earning of points may be restricted to on-location users, as indicated by the registry server. The registry server stores accessible metadata regarding the participating business. The metadata includes the business rules of the participating business and the results of the game. In a preferred embodiment, in order to participate in the game and earn the coupon users of the wireless communication devices must be present at the participating business.

The present invention relates to the delivery system and method of presenting promotions, discounts, advertising, and information to customers, and in particular, to coupon delivery system utilizing Internet connectivity paired with a device or component that enables participation based on a precise location.

### BACKGROUND OF THE INVENTION

It is a major challenge for most businesses to attract customers to their establishment. However, once a customer enters the business they are usually able to make a sale. Therefore, businesses such as restaurants invest a lot of time and money into bringing customers into the particular establishment. Currently there are many businesses which use direct mail campaigns offering paper coupons for the next visit to their establishment. Many businesses pay for expensive newspaper, magazine, Internet, television and radio advertisement. Also, most recently, there are other businesses which utilize Groupons available from groupon.com, which award coupons if a certain threshold of numbers of customers are met. All these methods provide some manner of benefit. However, they can be extremely expensive and often it is difficult to determine their effectiveness.

### Wi-Fi

Wi-Fi is short for “Wireless Fidelity” and refers to wireless networking technology that allows computers and other devices to communicate over a wireless signal. Wi-Fi service is typically provided by a gateway that also allows member nodes to access the wider internet. The gateway has features that prevent communication originating outside the network from accessing its member nodes.

### Gateway

A gateway is an off-the-shelf Internet Router that bridges a Local Area Network and another network, typically a Wide Area Network provided by an Internet Service Provider (ISP). A gateway has 2 IP Addresses, each one used separately by other nodes of, or traffic through, each network. Using a feature called Network Address Translation (NAT), a gateway will translate TCP requests coming through it from the LAN such they appear to have the Gateway's own IP Address.

### Local Gateway IP Address

A local gateway IP address is the address of the gateway as seen by computers on the Local Area Network. This address is unique only among the set of computers on the LAN.

### Outgoing Gateway IP Address

An outgoing gateway IP address is the address of the gateway as seen by computers outside the LAN. The outgoing gateway IP address is unique among computers in the WAN. The outgoing gateway IP address is not known or directly accessible to computers within the LAN, but it is automatically added to requests going through the gateway. This address may or may not be unique among the Internet at large, depending on the configuration of the ISP's network.

### Apparent Gateway IP Address

An apparent gateway IP address is the return IP address of queries and submissions sent to a server. It usually refers to the same outgoing gateway IP address previously defined. Because the Wide Area Networks between a client and server connected over the Internet may include more than one level of Network Address Translation, the outgoing gateway IP address is not guaranteed to be the same as the apparent gateway IP address for all LANs connecting to a particular server. The apparent gateway IP address is guaranteed to be the same for computers on a particular LAN connecting to a particular server.

### Application Software

Application software is all the computer software that causes a computer to perform useful tasks beyond the running of the computer itself. A specific instance of such software is called a software application, application program, application or App.

Many businesses offer low-cost or free Wi-Fi Internet service to their customers. But once online, being exposed to the Internet at large, customers have little awareness of each other or the host establishment.

What is needed is a method and device for allowing businesses to engage their Wi-Fi users and offer location-specific promotions, discounts and content.

### SUMMARY OF THE INVENTION

The present invention provides a system and method for awarding promotions, ads, and coupons to customers. A participating business provides a Wi-Fi Local Area Network that includes a location identifier. One or more hand held programmable wireless communication devices are present on the network. The location identifier and the wireless communication devices are in constant communication with a registry server, which is connected to the Local Area Network via the Internet. The registry server, using data provided by the location identifier, is able to aggregate wireless communication devices into a location-specific social network. The wireless communication devices are programmed to allow users to access and play a mobile game App to earn points. These points are converted into a coupon that can be redeemed at the participating business. Play of the game or earning of points may be restricted to on-location users, as indicated by the registry server. The registry server stores accessible metadata regarding the participating business. The metadata includes the business rules of the participating business and the results of the game as well as any technical data and content required to configure and play that game in the particular establishment. In a preferred embodiment, in order to participate in the game and earn the coupon users of the wireless communication devices must be present at the participating business.

### BRIEF DESCRIPTION OF THE DRAWINGS

FIG. 1 shows a preferred connectivity of the present invention.

FIG. 2 shows multiple Local Area Networks.

FIG. 3 shows a preferred smart phone screen.

FIGS. 4-8 show the steps of a preferred game.

### DETAILED DESCRIPTION OF THE PREFERRED EMBODIMENTS

The present invention allows a business to identify users that join the establishment's local Wi-Fi network through their wireless mobile devices. In doing so, promotions and coupons can be delivered to the customer as an award by simply accessing the provided application, in this case a “Game App”, which is unique to or configured specifically for the business. All publicly accessible services and content are managed in a central server.

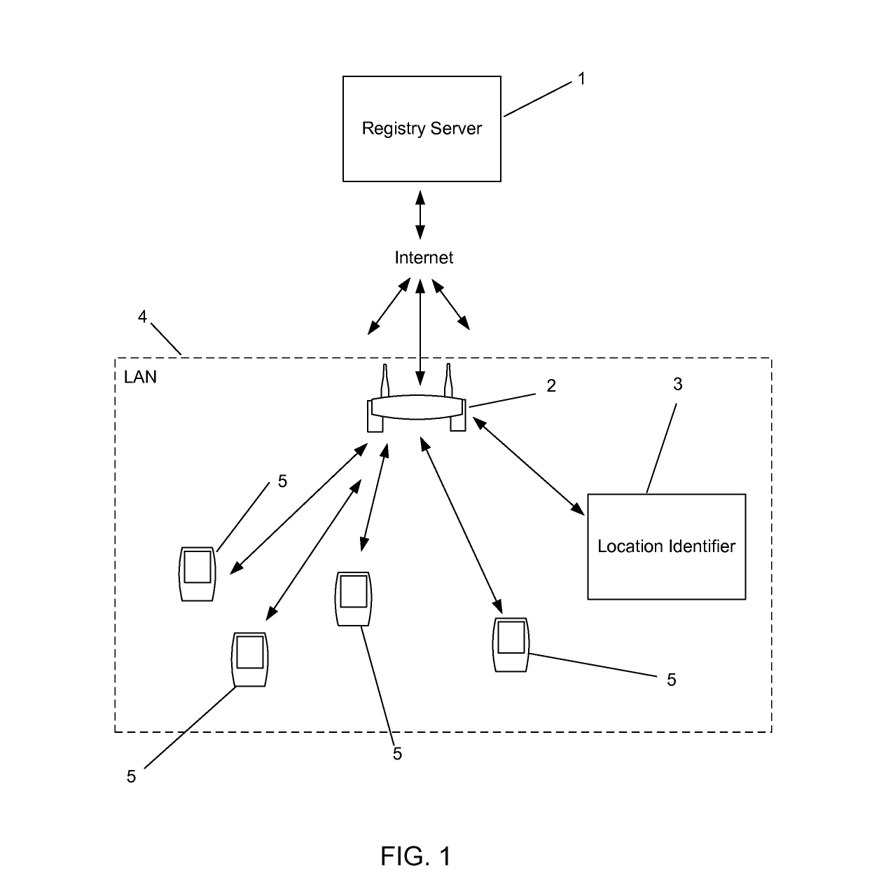

Local Area Network 4 with Internet connectivity is provided by a participating business that has installed a standard internet gateway 2 and made access to the gateway available to customers (FIG. 1). It is also accessed by a fixed component referred to as a location identifier 3 and hand held programmable wireless communication devices 5. All of these devices are in constant wireless communication with registry server 1 pertaining to the establishment.

Location identifier 3 transmits a known Client Identification Code (Client ID) and the gateway's Local IP address to registry server 1. En-route to registry server 1, the request gets the gateway's apparent IP Address added to it. Location identifier 3 can also provide the Client Identification Code if so queried.

Registry server 1 offers two types of services:
(1) One service receives the Client ID and Gateway IP Addresses indicated by location identifier 3 and stores them for future lookup, returning a simple acknowledgement.
(2) A second set of services receives a service method name and the automatically added apparent host IP address. Optionally, it can also receive the local gateway IP address or the Client ID of the establishment, although these will be employed far less frequently. Depending on which service method is requested, registry server 1 can return one or more of the following: stored metadata, content, business rules, community circles, and URLs for chat rooms and application messaging resources specific to that local network. Registry server 1 uses the apparent gateway IP address to identify the LAN that request originated from. In the rare case where more than one participating LAN is seen as having the same address, the local gateway IP address, if it has been provided, can be used to further identify the originating network. In case registry server 1 cannot uniquely identify the originating network, an appropriate error code expressing this condition is returned along with the list of IP addresses of the Location Identifiers of all networks that known by the registry server to share the indicated gateway address or addresses.

This network identification mechanism will allow the establishment to interface with the customers thru their mobile devices and deliver desired promotions by means of a game App. The users can access and play a mobile game App while inside the specified location to earn points. These points are converted into a coupon that can be redeemed at the participating business. In accordance with transmitted or pre-programmed business rules, some games and coupons may require the user to be present at the participating business.

FIG. 1 shows the connectivity of a preferred embodiment of the present invention. Multiple users each utilizing a smart phone 5 can join Local Area Network (LAN) 4 and connect to the Internet via a router or gateway device 2. In a preferred embodiment LAN 4 is established around a professional business (such as a restaurant) and location identifier 3. In a preferred embodiment location identifier device 3 is a programmed computer processing unit (CPU) 3.

Location identifier 3 notifies registry server 1 with information identifying itself and LAN 4. Location identifier 3 sends these notifications even if the data has not changed. While this data is en route to registry server 1, gateway 2 adds the outgoing Gateway IP address to the same data packet.

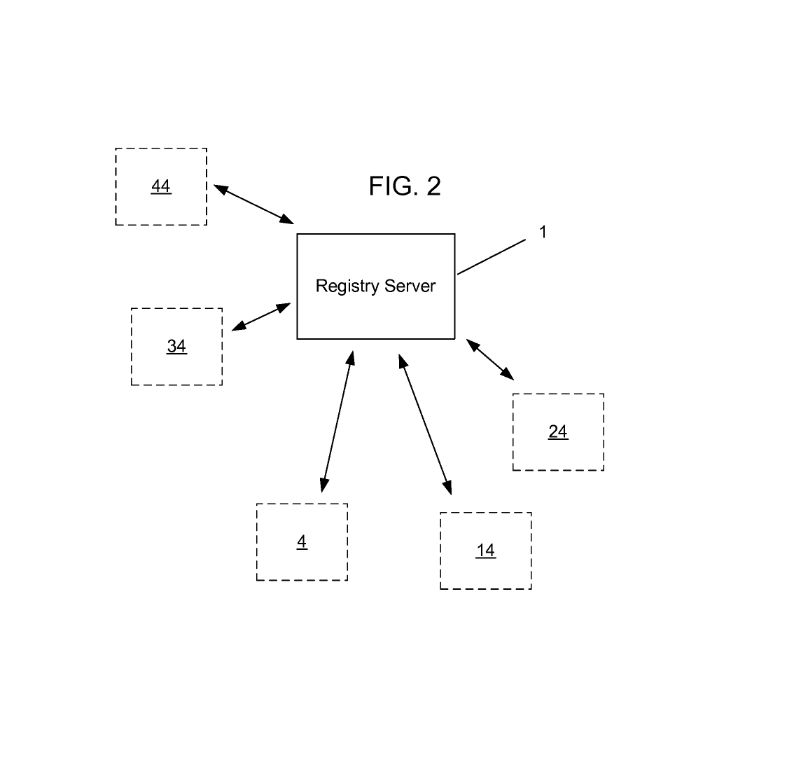

Registry server 1 includes programming to store data sent by location identifier 3 as well as return specific metadata linked to the particular establishment, and to store earned discounts or rewards. Registry server 1 can service inputs and queries from LAN 4 as well as other similarly established LANs (FIG. 2).

### Restaurant Purchase of the System

In a preferred embodiment of the present invention, an establishment such as a restaurant purchases a pre-programmed location identifier 3 and software (Game App) that permits connectivity to registry server 1. The restaurant also allows for Wi-Fi connectivity to smart phones 5. Registry server 1 has metadata entered that indicates the type of discounts and the circumstances in which they are earned as well as a unique code that location identifier 3 has been programmed with.

Once location identifier 3 is installed on the LAN and activated, it continuously notifies registry server 1 with the following 4 data fields:
1) The IP Address of the gateway 2,
2) The IP Address of location identifier 3,
3) The unique Client Identification Code, already known by registry server 1. Location identifier 3 has been programmed with the Client Identification Code in order to identify the establishment, and
4) The outgoing gateway IP Address of the LAN. En route to registry server 1, each data packet sent to the registry server is automatically augmented by router NAT technology with the outgoing gateway IP Address of the LAN.

These values enable two different ways of identifying nodes residing on the network when they communicate with register server 1—a faster, direct method that will usually suffice, and a slower indirect method that will always suffice. Both of these methods of discovering sibling network computers are faster than the current state of the art, which is a technique called TCP/IP broadcast.

Then, users utilizing smart phones 5 linked into LAN 4 can participate in games, social apps and business aware applications that are programmed with this feature. These apps may include features for mutual financial benefits such as earning coupons that can be used on a subsequent visit. This is beneficial for the restaurant because it brings customer foot traffic as well as repeat business which is a major challenge for many restaurants. For example, the customer must go to the restaurant to participate in the game. Then, the customer must go the restaurant on a subsequent visit to redeem the earned coupon. This, therefore will result in at least two customer visits that otherwise may not have occurred.

### Downloading and Installing the App

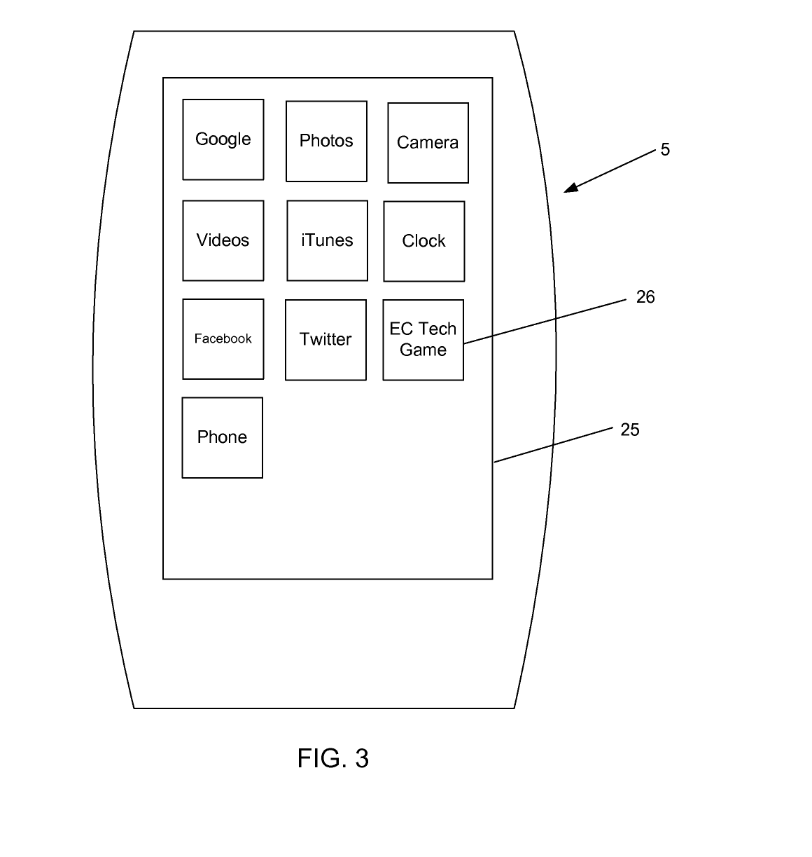

To utilize the present invention, the user will need to first download and install the appropriate programming onto his/her smart phone. In a preferred embodiment of the present invention, smart phone 5 is an iPhone® or iPad. iPhone® is a federally registered trademark owned by Apple, Inc. and refers in general to handheld mobile digital electronic devices for the sending and receiving of telephone calls, electronic mail, and other digital data, for use as a digital format audio player, and for use as a handheld computer, personal digital assistant, electronic organizer, electronic notepad, and camera. Preferably, the programming is an app that may be downloaded via the Internet and installed onto smart phone 5. After the app is installed onto smart phone 5, screen 25 appears as shown in FIG. 3 showing icon 26 “EC Tech Game”. EC Tech refers to the company that supplies the downloaded app. To access the installed app, the user will tap icon 26 with his finger.

### Joining the LAN

To join LAN 4, the user will need to physically travel to proximity close to the business establishment of interest. The user directs smart phone 5 to join the Wi-Fi network (LAN 4) according to the instructions provided by the establishment in a manner that may be specific to that type of phone. Smart phone 5 will typically remember these settings and automatically join this network in future visits.

### Joining the Logical Community

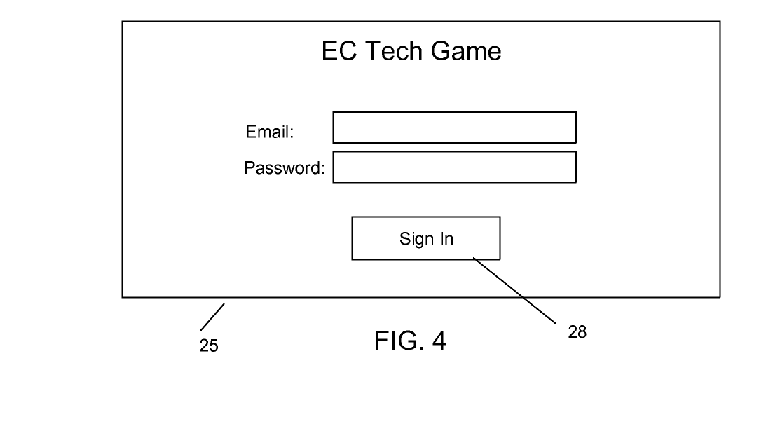

To join the community of users of LAN 4, the user does nothing beyond launching an app enabled with this feature. For example, in FIG. 1, LAN 4 is configured around a sushi restaurant. To start the app, the user clicks button 26 with his finger, then Screen 25 appears as shown in FIG. 4.

Immediately upon starting, the game or app queries registry server 1 for data concerning the local establishment. En route to the server, gateway 2 automatically adds the outgoing gateway IP address to the outgoing request. Registry server 1 pulls from its database the Client Identification Code or Codes associated with the apparent gateway IP address of the incoming request, and the optionally supplied local gateway IP address, if given. If more than one code is found, the server returns the list of location identifier IP addresses it has associated with the found identification codes as indicated in the ‘Ambiguity Resolution’ process described below. If a single identification code is found, (by far the most usual case) then it pulls from its database the metadata specific to the establishment using the single Client Identification Code and returns the metadata.

### Ambiguity Resolution

Because the structure of the intermediary internet networks are not known by the above described components and are getting increasingly sophisticated, the apparent gateway IP address may have more than one LAN's Client Identification Code associated with it, especially as more LANs participate and connect to a registry server.

If the indicated gateway IP address or addresses are associated with more than one LAN as seen by the registry server, the registry server returns the list of IP addresses of location identifiers on the identified LANs to the app on the user's mobile device. The app then queries the indicated IP addresses for the Client Identification Code programmed into location identifier 3. The metadata query is then submitted to registry server 1 a second time, this time with the unique Client Identification Code as a parameter.

### Signing into the Game App

As shown in FIG. 4, to sign into the game the user will first input his identifying information. He will input his email address and password. The user will then tap his finger onto button 28.

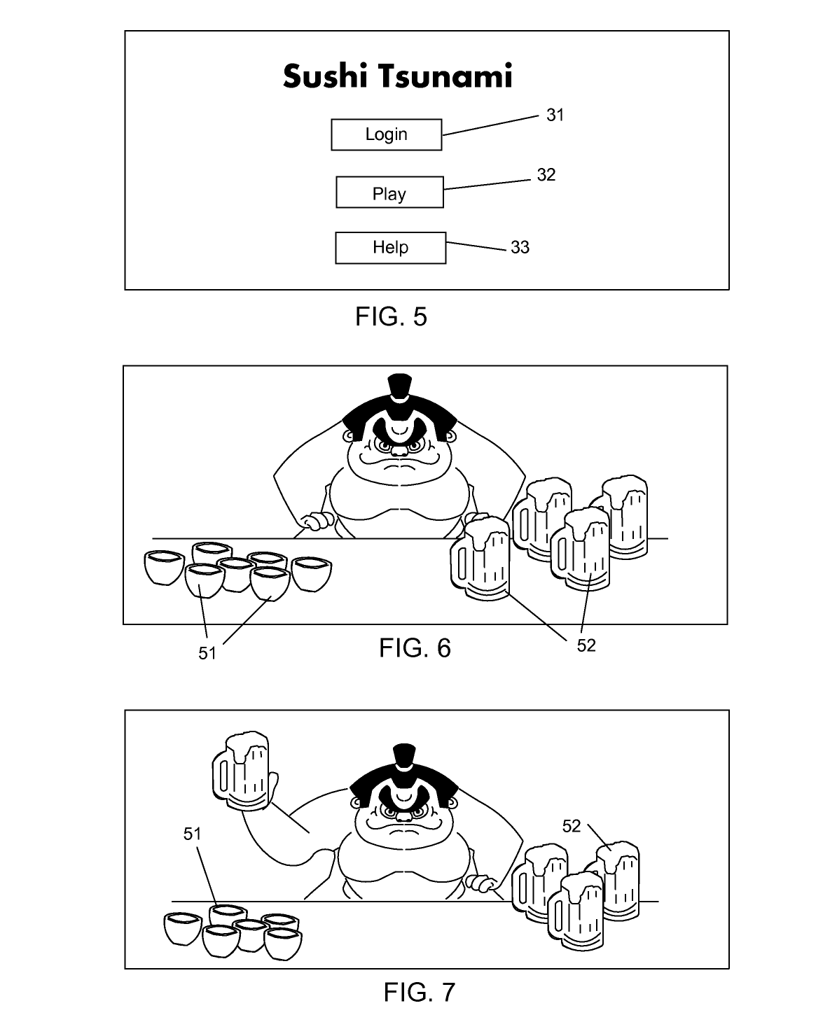

Screen 25 then appears as shown in FIG. 5. The user may then tap on button 31 to login as a different user, tap on button 32 to play the game App, or tap on button 33 if the user needs help. Preferably, there are multiple game Apps available to the user and customized to the needs of the business.

### Playing the Game App

The user has tapped on button 32 and screen 25 appears as shown in FIG. 6. The user is now ready to play the game pertaining to this particular restaurant called “Sushi Tsunami”. To play the game, the user places his finger on the hand of the character and drags his finger across screen 25 so that the character makes and drinks as many sake bombs as he can within a 2 minute time period. A sake bomb is made by pouring sake in shot glasses 51 into beer in beer glasses 52 (see also FIG. 7). The user is given points for each sake bomb successfully made and drunk.

### Game Over and Results

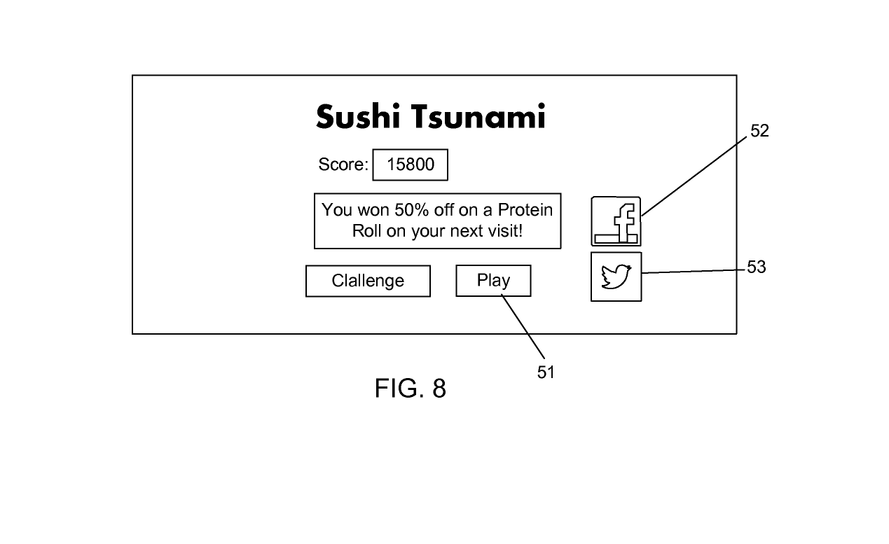

After the user has completed the game screen 25 appears as shown in FIG. 8. In the example discussed, the user's score is 15800. The business has predetermined that a score of 15800 entitles the user to a coupon that will give him 50% off on a protein roll on his next visit to the restaurant. The user may tap on button 51 to play again. The user also has the option of tapping on either button 52 or button 53 if he wishes to report the result of his score to a social networking website. For example, button 52 will report the results of the game to the user's Facebook® account. Button 53 will report the results of the game to the user's Twitter® account. Facebook® is a registered trademark of Facebook, Inc. and refers generally to computer services, namely, creating on-line virtual communities for registered users to organize groups and events, participate in discussions, and engage in social, business and community networking. Twitter® is a federally registered trademark of Twitter, Inc. and refers generally to telecommunication services, namely, providing online and telecommunication facilities for real-time interaction between and among users of computers, mobile and handheld computers, and wired and wireless communication devices. If the user reports his results on a social networking site, this will serve as free advertisement for the restaurant which could potentially bring in even more customers.

### Preferred Features of the Present Invention

In a preferred embodiment, the present invention rewards a user for participating in a smart phone game while partaking of a service or goods at an establishment. For example, the user can utilize his smart phone or a similar Wi-Fi capable device, such as a Wi-Fi tablet, for example the iPad®. In a preferred embodiment, the business, such as a restaurant sets targets based on points obtained by the player as tiers of how much of a discount they wish to give the customer to entice them to return. As stated above, the user may post the results of the game on his social networking website. The customer will be proudly publicizing his success in the game while at the same time promoting the game and the restaurant. Upon return to the restaurant the user can play the game again and/or use the previously earned coupon.

### Game Modifications

The above embodiments described a game called “Sushi Tsunami” that is appropriate for a Japanese food restaurant. However, it would be very easy to program a different game that rewards points that can be likewise converted to coupons, promotions, reward, etc. at various types of businesses. For example, an airline could utilize smart phones 5 that include programming depicting a game in which frequent flyers earn points by collecting the most pieces of luggage. Or, alternatively, a game could be fabricated that does not reward in terms of points but can allow advertisements or other exchange of information. For example, a supermarket can set a rule that if you reach a certain amount of points, they will in turn divulge when the next time Rib-Eye Steaks will be on sale. In a preferred embodiment of the present invention a customer is limited to just one coupon per visit. For example, in one preferred embodiment the customer may play the game repeatedly and the highest score will be used to award the coupon. In another preferred embodiment the customer may play the game repeatedly and the most recent score will be used to award the coupon.

### Customized Rules for the Establishment

An establishment, such as a restaurant, may customize its business rules to better facilitate its promotional goals. The customized business rules for each business establishment are stored as metadata at registry server 1. For example, each restaurant when joining can customize the difficulty of the game being played, they can customize the speed at which the game is played and the duration of the game. The establishment can customize the point threshold in which coupons or pertinent promotions are awarded. For example, 1000 points can correspond to a 50% coupon or alternatively 2000 points can correspond to a 50% coupon.

### Connectivity Details of a Preferred Embodiment of the Present Invention

FIG. 1 shows registry server 1 connected to the Internet. In a preferred embodiment of the present invention registry server 1 is a cloud based server that includes a computer or series of computers programmed used to maintain an internal database that functions as a repository of metadata regarding client establishments. The metadata is indexed by the Client Identification Codes. Separately, the Client Identification Codes are associated with the gateway IP Address or Addresses provided by those establishments through location identifier 3. IP Addresses or names may be clear text or encoded or hashed before transmission for security reasons. The host establishments represent physical facilities such as restaurants, homes, airports, schools and clubs, for example.

Wi-Fi capable Internet gateway device 2 is connected to the Internet as shown. In a preferred embodiment gateway device 2 is a modem/router that is Wi-Fi capable. Preferably, gateway device 2 is capable of establishing wireless Wi-Fi communication with Wi-Fi capable devices within the establishment. Local Area Network (LAN) 4 is established and it's accessed by the gateway device 2, location identifier and translator 3, and smart phones 5.

Location identifier 3 is connected to gateway device 2 as shown. This connection may be a wired or wireless connection. Location identifier 3 is programmed to connect to the Internet via gateway device 2. Location identifier 3 identifies the IP address of gateway device 2 and regularly sends the following information to the registry server 1: 1) the local gateway IP Address of the LAN 4 and 2) the location identifier's own IP address, and 3) a unique Client ID identifying the host establishment. Location identifier 3, in communicating with registry server 1 over standard internet infrastructure, allows these IP addresses to be reliably associated with the host establishment, even though they may be temporary and may be behind a NAT interface or reassigned by a DHCP controller. In a first preferred embodiment location identifier 3 is a stand alone module purchased by the host establishment. A stand alone module is preferred because it is very easily implanted and installed as a stand alone component. Alternatively, in another preferred embodiment, an existing business computer or CPU at the host establishment is programmed to perform the described specific functions of location identifier 3.

Smart phones 5 are wirelessly connected to gateway device 2 and are in communication with the location identifier and translator 3 and registry server 1. Each smart phone 5 preferably is programmed to quarry registry server 1 for information about the local establishment and locale-sensitive and time-sensitive data, configuration, and business rules used and required by mobile applications. In a preferred embodiment smart phones 5 are programmed when the user downloads application software (an app) via the Internet and installs the software onto the smart phone.

### Programming

Programming installed on smart phones 5, location identifier 3 and registry server 1 allows for certain automated processes. For example, location identifier 3 is programmed to automatically identify the local gateway IP Address of the local TCP/IP network and automatically transmit the local gateway IP, its own IP address, and the static Client ID to registry server 1. Registry server 1, continuously listening for incoming requests, receives the transmission from the location identifier 3 and updates its internal database, storing the local gateway IP, the apparent gateway IP address, and the location identifier's IP address.

### Steps for Establishing User Connectivity

The following steps describe a preferred method of establishing user connectivity via smart phones 5.

Step 1: User enters within range of the host establishment's wireless network, LAN 4 (FIG. 1).

Step 2: The user, via smart phone 5 either automatically or manually joins the host's wireless network.

Step 3: The user starts the appropriately enabled application on his or her smart phone 5.

Step 4: The app installed on smart phone 5 enables smart phone 5 to identify the gateway IP Address of the wireless network.

Step 5: Smart phone 5 transmits the gateway IP Address to registry server 1, querying metadata regarding the local establishment.

Step 6: Registry server 1:
A: Receives the request for metadata from Smart Phone Application installed on smart phone 5.
B. Queries its internal database for metadata by the apparent gateway IP address, plus the given local gateway IP address.
C. Returns the associated metadata to the Smart Phone application.

Step 7: The Smart Phone App on smart phone 5 receives the metadata and enables the features and business rules dictated by that metadata.

While the present invention has been described in terms of preferred embodiments, the reader should consider these described embodiments only as particular embodiments. Many other embodiments are possible. Therefore, the reader should determine the scope of the present invention by the claims and their legal equivalents.

What is claimed is:

1) A device for awarding coupons to customers comprising:
A. a Local Area Network surrounding a participating business, said Local Area Network comprising:
1. a gateway device,
2. a location identifier in communication with said gateway device,
3. at least one programmable hand held wireless communication device in communication with said gateway device, wherein said at least one wireless communication device and comprises programming that:
a) allows a user of the wireless communication device to play a game to earn points, and
b) converts said points into a coupon that can redeemed at said participating business,
B. a registry server in Internet connectivity with said Local Area Network, said registry server comprising metadata regarding said participating business, said metadata comprising business rules of said participating business and the results of said game,
wherein a user of said at least one wireless communication device must be within said Local Area Network to participate in said game and earn said coupon.

2) The device as in claim 1, wherein said registry server is a cloud based server used to maintain an internal database that functions as a repository of metadata regarding multiple participating businesses.

3) The device as in claim 1, wherein said gateway device is a cable modem that is Wi-Fi capable.

4) The device as in claim 1, wherein said location identifier is used and programmed to identify the IP address of said gateway device and regularly sends the following information to said registry server:
A. the local gateway IP Address of said Local Area Network,
B. a unique client ID identifying said participating business, and
C. the location identifier's own IP address.

5) The device as in claim 1, wherein said at least one programmable hand held wireless communication device is a programmed smart phone.

6) The device as in claim 1, wherein the results of said game are reported to a social networking site.

7) The device as in claim 1, wherein said awarded coupon can only be redeemed on a return visit.

8) The device as in claim 1, wherein said gateway device is a modem/router.

9) The device as in claim 1, wherein said registry server is at least one computer programmed to maintain an internal database that functions as a repository of metadata regarding multiple participating businesses.

10) The device as in claim 1, wherein said gateway device comprises an IP address, wherein said location identifier comprises an IP address and a Client Identification Code of said participating business, wherein said LAN comprises a outgoing gateway IP address, wherein said location identifier comprises programming to notify said registry server of:
A. said IP address of said gateway device,
B. said IP address of said location identifier,
C. said Client Identification Code of said participating business, and
D. said outgoing gateway IP address of said LAN.

11) A method for awarding coupons to customers, comprising the steps of:
A. establishing a Local Area Network surrounding a participating business, said Local Area Network comprising:
1. a gateway device,
2. a location identifier in communication with said gateway device,
3. at least one programmable hand held wireless communication device in communication with said gateway device, wherein said at least one wireless communication device comprises programming that:
a) allows a user of the wireless communication device to play a game to earn points, and
b) converts said points into a coupon that can redeemed at said participating business,
B. establishing a registry server in Internet connectivity with said Local Area Network, said registry server comprising metadata regarding said participating business, said metadata comprising business rules of said participating business and the results of said game,
wherein a user of said at least one wireless communication device must be within said Local Area Network to participate in said game and earn said coupon.

12) The method as in claim 11, wherein said registry server is a cloud based server used to maintain an internal database that functions as a repository of metadata regarding multiple participating businesses.

13) The method as in claim 11, wherein said gateway device is a cable modem that is Wi-Fi capable.

14) The method as in claim 11, wherein said location identifier is used and programmed to identify the IP address of said gateway device and regularly sends the following information to said registry server:
A. the local gateway IP Address of said Local Area Network,
B. a unique client ID identifying said participating business, and
C. the location identifier's own IP address.

15) The method as in claim 11, wherein said at least one programmable hand held wireless communication device is a programmed smart phone.

16) The method as in claim 11, wherein the results of said game are reported to a social networking site.

17) The method as in claim 10, wherein said awarded coupon can only be redeemed on a return visit.

18) The method as in claim 11, wherein said gateway device is a modem/router.

19) The method as in claim 11, wherein said registry server is at least one computer programmed to maintain an internal database that functions as a repository of metadata regarding multiple participating businesses.

20) The method as in claim 11, wherein said gateway device comprises an IP address, wherein said location identifier comprises an IP address and a Client Identification Code of said participating business, wherein said LAN comprises a outgoing gateway IP address, wherein said location identifier comprises programming to notify said registry server of:
A. said IP address of said gateway device,
B. said IP address of said location identifier,
C. said Client Identification Code of said participating business, and
D. said outgoing gateway IP address of said LAN.
